(19) United States
(12) Patent Application Publication
(10) Pub. No.: US 2024/0353236 A1
(43) Pub. Date: Oct. 24, 2024

(54) MAP UPDATE DEVICE AND METHOD FOR UPDATING A MAP

(71) Applicant: WOVEN BY TOYOTA, INC., Tokyo (JP)

(72) Inventors: Masaki TAKANO, Susono-shi (JP); Yusaku MANDAI, Tokyo-to (JP)

(73) Assignee: WOVEN BY TOYOTA, INC., Tokyo (JP)

(21) Appl. No.: 18/605,171

(22) Filed: Mar. 14, 2024

(30) Foreign Application Priority Data
Apr. 21, 2023 (JP) 2023-070299

(51) Int. Cl. G01C 21/00

(52) U.S. Cl. CPC G01C 21/3815; G01C 21/3833

(57) ABSTRACT

A map update device stores map information representing, for each of reference points of a predetermined feature, a representative position and a positional condition indicating a range where the reference point exists, in a map storage unit; determines whether the position of each of the reference points represented in pieces of surroundings data representing surroundings including the feature satisfies one or more positional conditions represented in the map information; and updates the map information for each of the reference points, using a position indicated by one of the one or more positional conditions as the representative position of the reference point. Positions of the reference point represented in the pieces of surroundings data obtained in a predetermined period are determined to satisfy the one of the one or more positional conditions at a rate satisfying an update condition.

### FIELD

The present disclosure relates to a map update device that updates map information and a method for updating a map.

### BACKGROUND

A known map-generating device collects surroundings data representing features around a vehicle, such as lane lines, obtained by a sensor mounted on the vehicle from the vehicle, and generates a high-precision map representing the features with high precision, using the collected surroundings data. The generated high-precision map is used for autonomous driving control of the vehicle.

When a road shape represented in a high-precision map as lane lines is changed, for example, because of construction, prompt update of the high-precision map based on the change in road shape is necessary. When a road shape is temporarily changed because of construction, update corresponding to a change from a road shape before the construction to a road shape during the construction and update corresponding to a change from the road shape during the construction to a road shape after the construction are made to a high-precision map.

In a map data update system described in Japanese Unexamined Patent Publication No. 2020-46203, a vehicle-mounted terminal obtains map data for update from a map update server and updates map data of the vehicle-mounted terminal. When update data after the start of a temporary road change is available, the map update server distributes the update data together with an instruction to temporarily use the update data. When update data after the end of a temporary road change is available, the map update server gives an instruction to use map data before the start of the temporary road change.

### SUMMARY

A map server detects a change in road shape from surroundings data collected from a vehicle, and generates map data representing the changed shape. Generation of map data representing a changed road shape after its change requires collection of a sufficient number of pieces of surroundings data for detecting the change, and requires nearly as much time as generation of map data representing a newly constructed road.

It is an object of the present disclosure to provide a map update device that can reduce the time required for updating map information.

The following is a summary of the present disclosure.

(1) A map update device including:
a memory configured to store map information representing, for each of reference points of a predetermined feature, a representative position and a positional condition indicating a positional range of the reference point; and
a processor configured to
   determine whether the position of each of the reference points represented in pieces of surroundings data representing surroundings including the feature satisfies one or more positional conditions represented in the map information, and
   update the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.

(2) The map update device according to aspect (1), wherein
the one or more positional conditions include a first positional condition corresponding to a first reference point among the reference points and a second positional condition different from the first positional condition, and
in the update, the processor updates the map information, using a position indicated by the second positional condition as the representative position of the first reference point, when positions of the first reference point represented in the pieces of surroundings data obtained in the predetermined period are determined not to satisfy the first positional condition, but to satisfy the second positional condition at a rate satisfying the update condition.

(3) The map update device according to aspect (2), wherein
the first positional condition is associated with a reference point indicating the position of a lane line defining a travel lane being traveled by a vehicle among lanes included in a road section being traveled by the vehicle, and
the second positional condition is associated with a reference point indicating the position of a lane line defining another of the lanes different from the travel lane.

(4) The map update device according to aspect (2), wherein
the first positional condition is associated with a reference point indicating the position of a lane line defining a travel lane being traveled by a vehicle among lanes included in a road section being traveled by the vehicle, and
the second positional condition is associated with a reference point indicating the position of a lane line that defined the travel lane in times past.

(5) The map update device according to any one of aspects (1) to (4), wherein in the update, the processor updates the map information, using a positional condition that satisfies the update condition as a positional condition corresponding to the reference point.

(6) The map update device according to any one of aspects (1) to (5), wherein
the positional conditions are probability distributions indicating the probabilities of existence of the reference points as a function of position, and
in the determination, the processor determines whether the position of each of the reference points represented in the pieces of surroundings data satisfies the one or more positional conditions, depending on whether the position of the reference point does not correspond to an outlier of probability distributions corresponding to the positional conditions.

(7) A method for updating a map executed by a map update device, the method including:
determining whether the position of each of reference points corresponding to a predetermined feature represented in pieces of surroundings data representing surroundings including the feature satisfies one or more positional conditions represented in map information by referring to the map information, wherein the map information is stored in a map storage unit and represents, for each of the reference points, a representative position and a positional condition indicating a positional range of the reference point; and
updating the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.

(8) A non-transitory computer-readable medium storing a computer program for updating a map, the computer program causing a processor to execute a process including:
determining whether the position of each of reference points corresponding to a predetermined feature represented in pieces of surroundings data representing surroundings including the feature satisfies one or more positional conditions represented in map information by referring to the map information, wherein the map information is stored in a map storage unit and represents, for each of the reference points, a representative position and a positional condition indicating a positional range of the reference point; and
updating the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.

The map update device according to the present disclosure can reduce the time required for updating map information.

### BRIEF DESCRIPTION OF DRAWINGS

FIG. 1 schematically illustrates the configuration of a map update system.

FIG. 2 schematically illustrates the configuration of a vehicle.

FIG. 3 illustrates the hardware configuration of a map update device.

FIG. 4 illustrates an example of map information.

FIG. 5 illustrates a first example of road conditions.

FIG. 6 is a functional block diagram of a processor included in the map update device.

FIG. 7 illustrates a second example of road conditions.

FIG. 8 is a flowchart of a map update process.

### DESCRIPTION OF EMBODIMENTS

A map update device that can reduce the time required for updating map information will now be described in detail with reference to the attached drawings. The map update device stores map information representing, for each of reference points of a predetermined feature, a representative position and a positional condition indicating a range where the reference point exists, in a map storage unit.

The map update device determines whether the position of each of the reference points represented in pieces of surroundings data representing surroundings including the feature satisfies one or more positional conditions represented in the map information.

The map update device updates the map information for each of the reference points, using a position indicated by one of the one or more positional conditions as the representative position of the reference point. Positions of the reference point represented in the pieces of surroundings data obtained in a predetermined period are determined to satisfy the one of the one or more positional conditions at a rate satisfying an update condition.

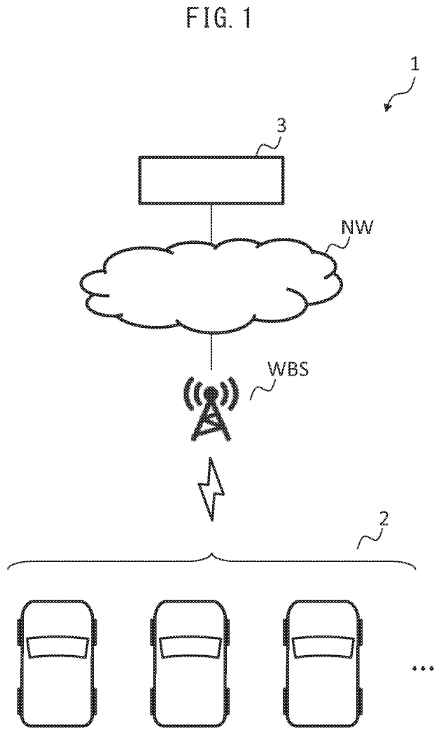

FIG. 1 schematically illustrates the configuration of a map update system. In the present embodiment, the map update system 1 includes multiple vehicles 2 and a map update device 3. Each of the vehicles 2 accesses a wireless base station WBS, which is connected, for example, via a gateway (not illustrated) to a communication network NW connected with the map update device 3, thereby communicably connecting to the map update device 3 via the wireless base station WBS and the communication network NW. In the following, one of the vehicles 2 will be referred to as a “vehicle 2.” In the map update system 1, the communication network NW may be connected with multiple wireless base stations WBS.

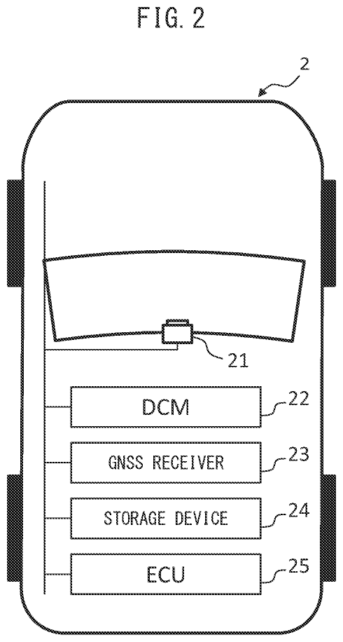

FIG. 2 schematically illustrates the configuration of the vehicle 2.

The vehicle 2 includes a camera 21 for generating images of the surroundings, a data communication module (DCM) 22, a global navigation satellite system (GNSS) receiver 23, a storage device 24, and an electronic control unit (ECU) 25. The camera 21, the data communication module 22, the GNSS receiver 23, and the storage device 24 are communicably connected to the ECU 25 via an in-vehicle network conforming to a standard such as a controller area network.

The camera 21 is an example of a sensor for generating a surroundings image depending on the surroundings of the vehicle 2. The camera 21 includes a two-dimensional detector constructed from an array of optoelectronic transducers, such as CCD or C-MOS, having sensitivity to visible light and a focusing optical system that forms an image of a target region on the two-dimensional detector. The camera 21 is disposed, for example, in a front upper area in the vehicle interior and oriented forward. The camera 21 takes pictures of the surroundings of the vehicle 2 through a windshield or a rear window every predetermined capturing period (e.g., 1/30 to 1/10 seconds), and outputs surroundings images representing the surroundings.

The data communication module 22, which is an example of a communication device, is a device to execute a wireless communication process conforming to a predetermined standard of wireless communication, such as “4G (4th Generation)” or “5G (5th Generation).” The data communication module 22 accesses, for example, the wireless base station WBS to communicably connect to the map update device 3 via the wireless base station WBS and the communication network NW. The data communication module 22 includes surroundings data received from the ECU 25 in an uplink radio signal, and transmits the radio signal to the wireless base station WBS, thereby transmitting the surroundings data to the map update device 3. The data communication module 22 may be mounted as part of the ECU 25.

The GNSS receiver 23, which is an example of a position determining sensor, receives GNSS signals from GNSS satellites with a GPSS antenna (not illustrated) at predetermined intervals, and determines the position of the vehicle 2, based on the received GNSS signals. The GNSS receiver 23 outputs a positioning signal indicating the result of determination of the position of the vehicle 2 based on the GNSS signals to the ECU 25 via the in-vehicle network at predetermined intervals.

The storage device 24, which is an example of vehicle storage, includes, for example, a nonvolatile semiconductor memory or a hard disk drive. The storage device 24 stores vehicle map information representing a representative position for each of reference points of a predetermined feature in a predetermined road section. The vehicle map information may be all or part of map information to be updated by the map update device 3. Further, the storage device 24 temporarily stores predetermined-period's surroundings data outputted by the camera 21.

The ECU 25 includes a communication interface circuit for connecting the ECU 25 to the in-vehicle network, a memory configured to store various types of data and programs, and a processor configured to execute a process according to a program stored in the memory.

The ECU 25 obtains a surroundings image generated by the camera 21 via the communication interface circuit. The ECU 25 inputs the surroundings image into a classifier that has been trained to detect a feature from an image, thereby detecting a feature in a surrounding area from the surroundings image.

The classifier may be, for example, a convolutional neural network (CNN) including convolution layers connected in series from the input side toward the output side, such as You Only Look Once (YOLO) or Single Shot MultiBox Detector (SSD). A CNN that has been trained using a large number of images representing detection target features, such as lane lines, as training data in accordance with a predetermined training technique, such as backpropagation, operates as a classifier that detects a feature.

The ECU 25 estimates the position and orientation of the vehicle 2 at the time of generation of the surroundings image by matching the position of the feature detected from the surroundings image with the position of the feature read from the storage device 24. The ECU 25 may identify the position and orientation of the vehicle 2, based on the position of the vehicle indicated by a positioning signal received from the GNSS receiver 23 and orientation information obtained from an orientation sensor (not illustrated) mounted on the vehicle 2.

To detect reference points provided on a lane line at predetermined intervals (e.g., 50 m) from a reference location, such as an intersection or a merge point, the ECU 25 identifies a surroundings image generated by the camera 21 when the vehicle 2 reaches a position where the distance between a position that is a predetermined distance (e.g., 5 m) ahead of the position of the vehicle 2 in the travel direction and the representative position of a reference point stored in the vehicle map information is the smallest. The ECU 25 can detect the position of the reference point on the lane line by detecting the position of the lane line at the predetermined distance ahead of the position of the vehicle 2 in the travel direction in this surroundings image. The predetermined interval is preset for the map information. The predetermined distance is preset, depending on capturing parameters, such as the focal length of the optical system of the camera 21 and the direction in which pictures are taken, and is stored in the memory.

The ECU 25 estimates the position of the reference point in the surroundings image. The ECU 25 transforms the estimated position of the reference point into a position in the world coordinate system, using the position and orientation of the vehicle 2, the capturing parameters of the camera 21, and the space between lane lines included in a high-precision map.

The ECU 25 transmits data indicating the identifier and position of a predetermined reference point, as surroundings data representing surroundings including a lane line, to the map update device 3 via the data communication module 22.

The ECU 25 may transmit the surroundings image, the position and orientation of the vehicle 2, and the capturing parameters of the camera 21 to the map update device 3 as surroundings data. In this case, the map update device 3 calculates the position of the reference point, based on the surroundings data.

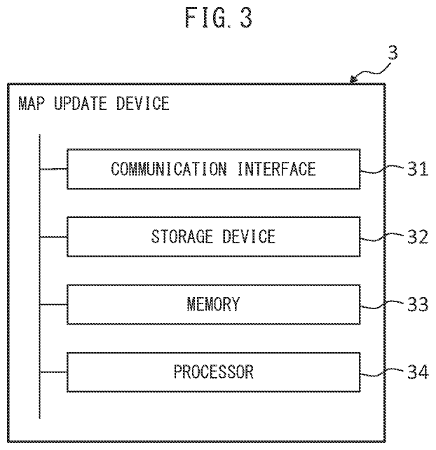

FIG. 3 illustrates the hardware configuration of the map update device 3. The map update device 3 includes a communication interface 31, a storage device 32, a memory 33, and a processor 34.

The communication interface 31, which is an example of a communication unit, includes an interface circuit for connecting the map update device 3 to the communication network NW. The communication interface 31 is configured to be communicable with another device via the communication network NW. More specifically, the communication interface 31 passes, to the processor 34, data received from a device via the communication network NW, and transmits data received from the processor 34 to a device via the communication network NW.

The storage device 32, which is an example of the map storage unit, includes storage, such as a hard disk drive or a nonvolatile semiconductor memory device. The storage device 32 stores map information representing, for each of reference points of a predetermined feature, a representative position and a positional condition indicating a range where the reference point exists. The storage device 32 may store pieces of surroundings data received from the vehicle 2. The map storage unit may be a separate storage device communicably connected to the map update device 3.

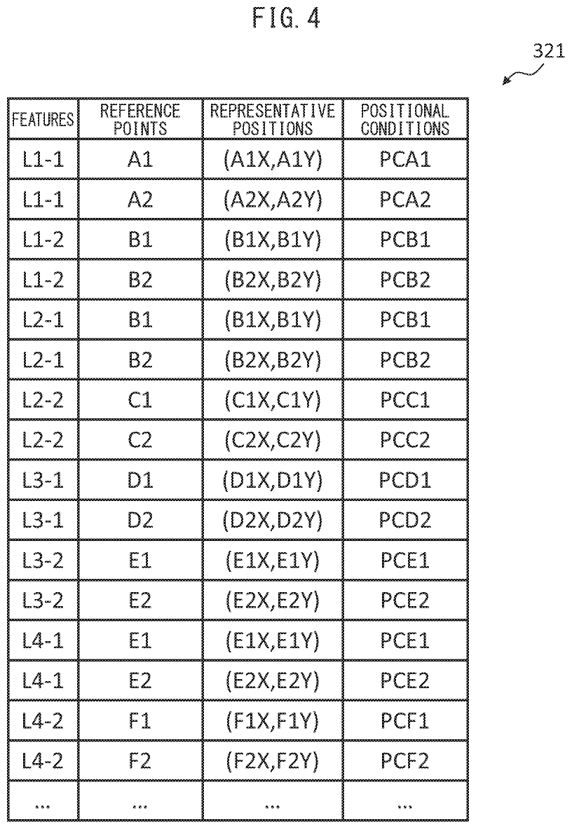

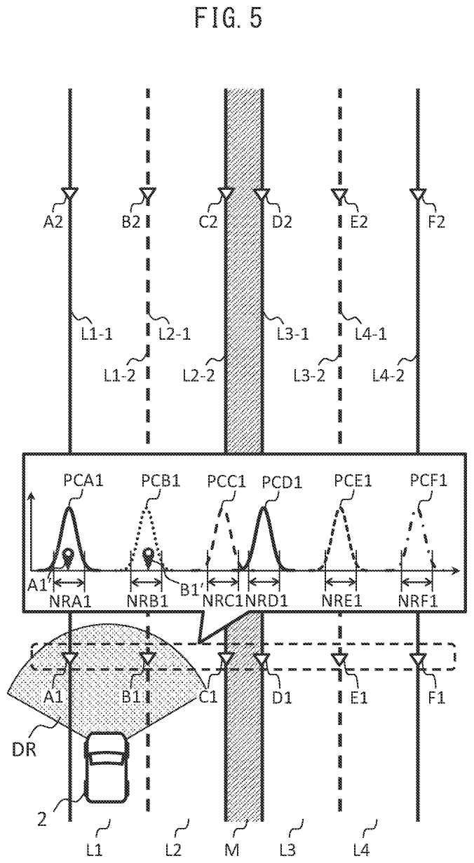

FIG. 4 illustrates an example of map information whereas FIG. 5 illustrates a first example of road conditions. The first example of road conditions illustrates conditions of a road including lanes L1 and L2, a median strip M, and lanes L3 and L4.

In map information 321 illustrated in FIG. 4, reference points A1 and A2 are those of a lane line L1-1 of a pair of lane lines defining the lane L1 illustrated in FIG. 5. A lane line is an example of a feature stored in the map storage unit as map information. Reference points of a lane line are provided at predetermined intervals, for example, from a reference location of its road, such as an intersection or a merge point. Reference points B1 and B2 are those of the other lane line L1-2 of the lane lines defining the lane L1.

In the example of FIG. 5, the reference points B1 and B2 of the other lane line L1-2 of the lane lines defining the lane L1 are also used as reference points corresponding to a lane line L2-1 of the lane lines defining the lane L2. However, the reference points of the lane line L2-1 of the lane lines defining the lane L2 may be provided separately from those of the other lane line L1-2 of the lane lines defining the lane L1.

In the map information 321 illustrated in FIG. 4, the reference point A1 is associated with a representative position (A1X, A1Y) and a positional condition PCA1. The representative position is a position at which the reference point is assumed to exist at generating a map based on the map information. AIX and A1Y of the representative position (A1X, A1Y) denote the latitude and longitude of the reference point, respectively.

The positional condition PCA1 indicates a range where the reference point A1 exists. The positional condition PCA1 may be a probability distribution indicating the probability of existence of the reference point represented in surroundings data obtained by the vehicle 2 as a function of position. A positional condition may be set based on surroundings data representing conditions of a feature received from the vehicle 2. As illustrated in FIG. 4, positional conditions PCA1 to PCF1 corresponding to reference points A1 to F1 are stored in the map information 321. A representative position may be a statistically representative value, such as an arithmetic mean or a median, of a probability distribution that is set as a positional condition.

Referring back to FIG. 3, the memory 33, which is another example of the storage unit, includes volatile and nonvolatile semiconductor memories. The memory 33 stores various types of data used for processing by the processor 34, e.g., an update condition for determining whether to update the map information 321, using a position indicated by a predetermined positional condition as the representative position of a reference point. The memory 33 also stores various application programs, e.g., a computer program for updating a map. This program is for updating the map information 321.

The processor 34 includes one or more central processing units (CPUs) and a peripheral circuit thereof. The processor 34 may further include another operating circuit, such as a logic-arithmetic unit or an arithmetic unit.

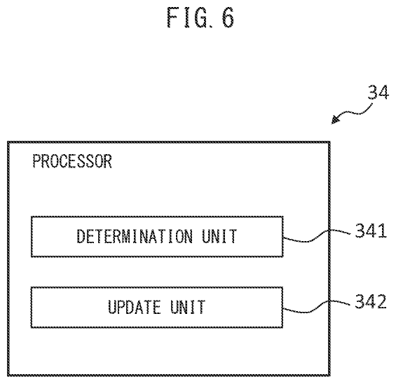

FIG. 6 is a functional block diagram of the processor 34 included in the map update device 3.

As its functional blocks, the processor 34 of the map update device 3 includes a determination unit 341 and an update unit 342. These units included in the processor 34 are functional modules implemented by a program executed by the processor 34. The computer program for achieving the functions of the units of the processor 34 may be provided in a form recorded on a computer-readable portable storage medium, such as a semiconductor memory, a magnetic medium, or an optical medium. Alternatively, the units included in the processor 34 may be implemented in the map update device 3 as separate integrated circuits, microprocessors, or firmware.

The determination unit 341 determines whether the position of each of reference points represented in pieces of surroundings data representing surroundings including a feature satisfies one or more positional conditions stored in the storage device 32.

The determination unit 341 reads out one of pieces of surroundings data from the storage device 32, and identifies a reference point represented in the read-out surroundings data. The determination unit 341 selects one or more positional conditions such that there is a representative position within a predetermined range (e.g., 100 m) of a representative position corresponding to the reference point represented in the read-out surroundings data, from the map information. The determination unit 341 then determines whether the reference point represented in the read-out surroundings data satisfies the selected one or more positional conditions. For each reference point, the determination unit 341 temporarily stores the results of determination regarding the selected one or more positional conditions, in the memory 33.

When a probability distribution indicating the probability of existence of a reference point represented in surroundings data obtained by the vehicle 2 as a function of position is set as a positional condition, the determination unit 341 may determine whether the position of the read-out reference point satisfies the selected one or more positional conditions, depending on whether the position of the reference point does not correspond to an outlier of probability distributions corresponding to the positional conditions. For example, the determination unit 341 assumes a position outside a normal range, such as average±standard deviation×2 for the case where a probability distribution that is set as a positional condition is approximated with a normal distribution, to be an outlier, and determines that a reference point at such a position does not satisfy the positional condition. To determine whether to correspond to an outlier may be applied a conventional technique such as Smirnov-Grubbs test or determination based on a percentile value.

In the first example of road conditions illustrated in FIG. 5, a position A1′ corresponding to the reference point A1 and a position B1′ corresponding to the reference point B1 are included in surroundings data representing reference points in a range DR detected by the camera 21 of the vehicle 2. The determination unit 341 selects the positional conditions PCA1 to PCF1 such that there is a representative position within the predetermined range of the representative position (A1X, A1Y) of the reference point A1.

Assume that the reference point A1 is a first reference point, the positional condition PCA1 corresponding to the first reference point is a first positional condition, and the positional condition PCD1 different from the first positional condition is a second positional condition. In the first example of road conditions illustrated in FIG. 5, the first positional condition is associated with a reference point indicating the position of a lane line defining the lane L1 being traveled by the vehicle 2 among the lanes L1 to L4 included in the road being traveled by the vehicle 2. The second positional condition is associated with a reference point indicating the position of a lane line defining the lane L3 that is not traveled by the vehicle 2 among the lanes L1 to L4 included in the road being traveled by the vehicle 2.

Since the position A1′ represented in the surroundings data is not outside a normal range NRA1 of the first positional condition, the determination unit 341 determines that the position A1′ satisfies the first positional condition. Since the position A1′ represented in the surroundings data is outside a normal range NRD1 of the second positional condition, the determination unit 341 determines that the position A1′ does not satisfy the second positional condition.

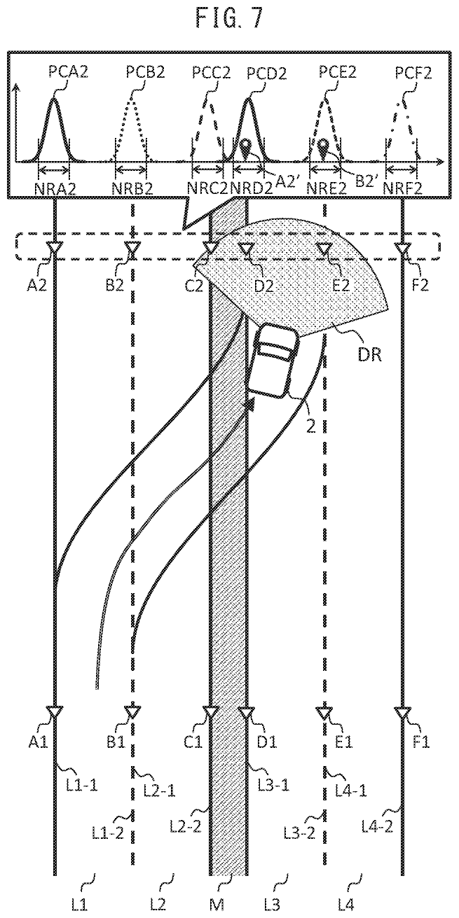

FIG. 7 illustrates a second example of road conditions. The second example of road conditions illustrates a situation in which the lanes L1 and L2 in the first example of road conditions illustrated in FIG. 5 are blocked midway, for example, because of construction, and part of the lane L3 is changed to the lane L1.

In the second example of road conditions illustrated in FIG. 7, a position A2′ corresponding to the reference point A2 and a position B2′ corresponding to the reference point B2 are included in surroundings data representing reference points in a range DR detected by the camera 21 of the vehicle 2. The determination unit 341 selects positional conditions PCA2 to PCF2 such that there is a representative position within the predetermined range of the representative position (A2X, A2Y) of the reference point A2.

Assume that the reference point A2 is a first reference point, the positional condition PCA2 corresponding to the first reference point is a first positional condition, and the positional condition PCD2 different from the first positional condition is a second positional condition. In the second example of road conditions illustrated in FIG. 7, the first positional condition is associated with a reference point indicating the position of a lane line defining the lane L1 being traveled by the vehicle 2 among the lanes L1 to L4 included in the road being traveled by the vehicle 2. The second positional condition is associated with a reference point indicating the position of a lane line defining the lane L3 that is not traveled by the vehicle 2 among the lanes L1 to L4 included in the road being traveled by the vehicle 2.

Since the position A2′ represented in the surroundings data is outside a normal range NRA2 of the first positional condition, the determination unit 341 determines that the position A2′ does not satisfy the first positional condition. Since the position A2′ represented in the surroundings data is not outside a normal range NRD2 of the second positional condition, the determination unit 341 determines that the position A2′ satisfies the second positional condition.

Referring back to FIG. 6, the update unit 342 updates the map information for each of the reference points, using a position indicated by one of the one or more positional conditions as the representative position of the reference point. Positions of the reference point represented in the pieces of surroundings data obtained in a predetermined period are determined to satisfy the one of the one or more positional conditions at a rate satisfying an update condition.

The predetermined period is preset, depending on the frequency at which surroundings data of a road section including reference points is obtained, and is, for example, one week. For example, the update condition is a condition that positions of a reference point represented in pieces of surroundings data obtained in the predetermined period are determined to satisfy a positional condition at a rate greater than an update threshold (e.g., 60%).

In the second example of road conditions illustrated in FIG. 7, the positional condition PCA2 associated with the reference point A2 represents the distribution of positions of the reference point detected from surroundings data obtained before the change in road shape. The vehicle 2 follows the changed road shape, and detects a position corresponding to the lane line that defined the lane L3 before the change in road shape, as a reference point that is a predetermined distance away from the immediately preceding reference point A1.

Before the change in road shape, the position of the reference point represented in surroundings data basically satisfies the positional condition PCA2 and does not satisfy the positional condition PCD2. After the change in road shape, the vehicle 2 following the changed road shape obtains more pieces of surroundings data representing the position of the reference point that does not satisfy the positional condition PCA2 but satisfies the positional condition PCD2, as time passes. When positions of the reference point represented in pieces of surroundings data satisfy the positional condition PCD2 at a sufficiently high rate satisfying the update condition after the predetermined period, the update unit 342 updates the map information 321, using a position indicated by the positional condition PCD2 as the representative position of the reference point A2.

Assume that the reference point A2 is a first reference point, the positional condition PCA2 corresponding to the first reference point is a first positional condition, and the positional condition PCD2 different from the first positional condition is a second positional condition. In this case, the update unit 342 may update the map information 321, using a position indicated by the second positional condition as the representative position of the first reference point, when positions of the first reference point represented in the pieces of surroundings data obtained in the predetermined period are determined not to satisfy the first positional condition but to satisfy the second positional condition at a rate satisfying the update condition.

The update unit 342 may update the map information 321, using a positional condition indicating an updated representative position of a reference point as a positional condition of the reference point.

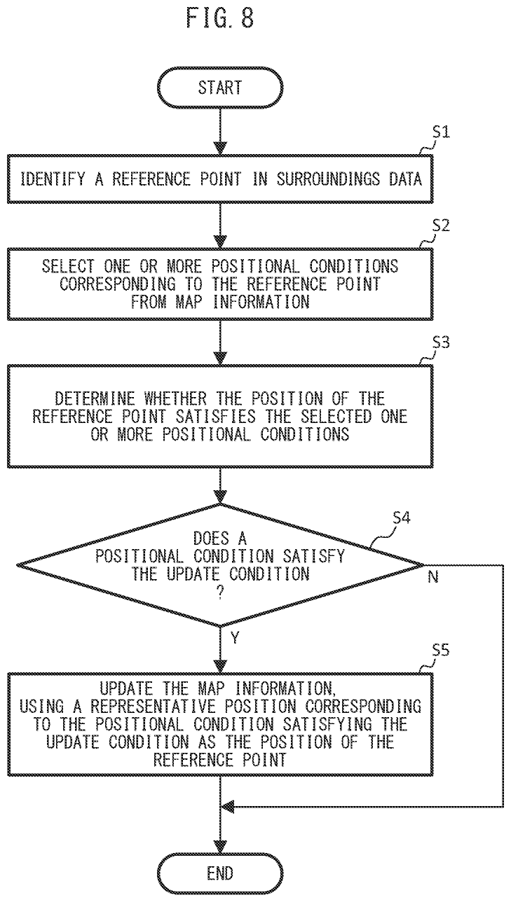

FIG. 8 is a flowchart of a map update process. The processor 34 of the map update device 3 executes the map update process illustrated in FIG. 7 for each of reference points represented in pieces of surroundings data.

First, the determination unit 341 of the processor 34 identifies a reference point among the reference points represented in the pieces of surroundings data (step S1).

The determination unit 341 then selects one or more positional conditions corresponding to the identified reference point from the map information 321 stored in the storage device 32 (step S2).

Subsequently, the determination unit 341 determines whether the position of the identified reference point satisfies the selected one or more positional conditions, and temporarily stores the results of determination in the memory 33 (step S3).

The update unit 342 of the processor 34 determines whether the selected one or more positional conditions includes a positional condition such that positions of the reference point represented in the pieces of surroundings data obtained in the predetermined period are determined to satisfy the positional condition at a rate satisfying the update condition (step S4). When no positional condition satisfies the update condition (No in step S4), the update unit 342 terminates the map update process for the reference point represented in the pieces of surroundings data.

When a positional condition satisfies the update condition (Yes in step S4), the update unit 342 updates the map information 321, using a representative position corresponding to the positional condition satisfying the update condition as the position of the reference point (step S5), and terminates the map update process for the reference point represented in the pieces of surroundings data.

The map update process executed in this way eliminates the need for storing new surroundings data for making a positional condition, enabling the map update device 3 to reduce the time required for updating map information and to provide vehicles with map information representing the latest road shapes.

In the example described in the present embodiment, a positional condition associated with a reference point of a lane line defining a travel lane is updated with a positional condition associated with a reference point of a lane line defining another lane in response to a change in road shape in which part of the latter lane is changed to the former lane. However, the map update device 3 according to the present disclosure can also reduce the time required for updating map information in the case of a change in road shape other than the example of the present embodiment. For example, assume that the road shape in the second example of road conditions illustrated in FIG. 7 is changed again to the road shape in the first example of road conditions illustrated in FIG. 5. In this case, the positional condition PCD2 is associated with a reference point D2 indicating the position of a lane line defining a travel lane being traveled by the vehicle whereas the positional condition PCA2 is associated with the reference point A2 indicating the position of a lane line that defined the travel lane in times past. By executing the map update process with the positional conditions PCD2 and PCA2 used as first and second positional conditions, respectively, the map update device 3 can update the map information, using a position indicated by the positional condition PCA2 as the representative position of the reference point A2 indicating the position of a lane line defining a new travel lane after the change in shape.

The map update device 3 of the present disclosure can also reduce the time required for updating a feature in map information other than a lane line, e.g., a road marking, such as a stop line or a speed sign, a railroad crossing, or a tunnel, as in the case of a lane line.

In the example described in the present embodiment, the position of a reference point is expressed in two dimensions, e.g., by latitude and longitude. The map update device according to the present disclosure can also operate similarly when the position of a reference point is expressed in three dimensions, e.g., by latitude, longitude, and altitude.

It should be noted that those skilled in the art can make various changes, substitutions, and modifications without departing from the spirit and scope of the present disclosure.

What is claimed is:

1. A map update device comprising:
a memory configured to store map information representing, for each of reference points of a predetermined feature, a representative position and a positional condition indicating a positional range of the reference point; and
a processor configured to
determine whether the position of each of the reference points represented in pieces of surroundings data representing surroundings including the feature satisfies one or more positional conditions represented in the map information, and
update the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.

2. The map update device according to claim 1, wherein
the one or more positional conditions include a first positional condition corresponding to a first reference point among the reference points and a second positional condition different from the first positional condition, and
in the update, the processor updates the map information, using a position indicated by the second positional condition as the representative position of the first reference point, when positions of the first reference point represented in the pieces of surroundings data obtained in the predetermined period are determined not to satisfy the first positional condition but to satisfy the second positional condition at a rate satisfying the update condition.

3. The map update device according to claim 2, wherein
the first positional condition is associated with a reference point indicating the position of a lane line defining a travel lane being traveled by a vehicle among lanes included in a road section being traveled by the vehicle, and
the second positional condition is associated with a reference point indicating the position of a lane line defining another of the lanes different from the travel lane.

4. The map update device according to claim 2, wherein
the first positional condition is associated with a reference point indicating the position of a lane line defining a travel lane being traveled by a vehicle among lanes included in a road section being traveled by the vehicle, and
the second positional condition is associated with a reference point indicating the position of a lane line that defined the travel lane in times past.

5. The map update device according to claim 1, wherein in the update, the processor updates the map information, using a positional condition that satisfies the update condition as a positional condition corresponding to the reference point.

6. The map update device according to claim 1, wherein
the positional conditions are probability distributions indicating the probabilities of existence of the reference points as a function of position, and
in the determination, the processor determines whether the position of each of the reference points represented in the pieces of surroundings data satisfies the one or more positional conditions, depending on whether the position of the reference point does not correspond to an outlier of probability distributions corresponding to the positional conditions.

7. A method for updating a map executed by a map update device, the method comprising:
determining whether the position of each of reference points of a predetermined feature represented in pieces of surroundings data representing surroundings including the feature satisfies one or more positional conditions represented in map information by referring to the map information, wherein the map information is stored in a memory and represents, for each of the reference points, a representative position and a positional condition indicating a positional range of the reference point; and
updating the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.

8. A non-transitory computer-readable medium storing a computer program for updating a map, the computer program causing a processor to execute a process comprising:
determining whether the position of each of reference points of a predetermined feature represented in pieces of surroundings data representing surroundings including the feature satisfies one or more positional conditions represented in map information by referring to the map information, wherein the map information is stored in a memory and represents, for each of the reference points, a representative position and a positional condition indicating a positional range of the reference point, and
updating the map information for each of the reference points, using a position indicated by one of the one or more positional conditions as the representative position of the reference point, wherein positions of the reference point represented in the pieces of surroundings data obtained in a predetermined period are determined to satisfy the one of the one or more positional conditions at a rate satisfying an update condition.
